(19) United States
(12) Patent Application Publication
(10) Pub. No.: US 2026/0145106 A1
(43) Pub. Date: May 28, 2026

(54) EXTRUDED NETTING FOR FILTERS

(71) Applicant: DeIStar Technologies, Inc., Alpharetta, GA (US)

(72) Inventors: Paul J. Huspeni, Alpharetta, GA (US); Joel Patrick Trojnar, Smyrna, PA (US); James Sandy, Alpharetta, GA (US); Chipper Darling, Alpharetta, GA (US); Andrew G. Platt, Middletown, DE (US)

(21) Appl. No.: 19/392,272

(22) Filed: Nov. 18, 2025

Related U.S. Application Data
(60) Provisional application No. 63/723,759, filed on Nov. 22, 2024.

(51) Int. Cl. B01D 39/16; B01D 29/21; B01D 61/02

(52) U.S. Cl. CPC B01D 39/163; B01D 29/21; B01D 61/02; B01D 2201/12; B01D 2239/0208; B01D 2239/1233; B01D 2239/1291; B01D 2313/14

(57) ABSTRACT

Filter media and filters are provided that are formed from extruded reticular structures, such as nettings or meshes, and may be used in a variety of demanding filter applications that require high resistance to elevated temperatures, chemical reactions, corrosion, stress-cracking and wear. A filter media comprises an extruded reticular structure comprising an array of intersecting monofilaments or strands bonded to each other. The strands each have a thickness of about 4 mils to about 8 mils and comprise a high-temperature thermoplastic material. The high-temperature thermoplastic material is selected to resist deformation at elevated temperatures to avoid compromising the integrity of the filter and to exhibit thermal stability such that it can endure continuous service at elevated temperatures.

### CROSS-REFERENCE TO RELATED APPLICATIONS

This This application claims the benefit of U.S. Provisional Application Ser. No. 63/723,759, filed Nov. 22, 2024, the complete disclosure of which is incorporated herein by reference.

### TECHNICAL FIELD

This description generally relates to filter media and filters, and more particularly to filter media comprising intersecting strands or monofilaments that form an extruded reticular structure.

### BACKGROUND

Liquid and gas filters trap and remove particles of many different types from air, water, oil, fuel, chemicals, solutions, rinsing agents, gases and other fluids. Liquid filter cartridges, for example, may be used in a variety of industrial applications to remove contaminants and impurities from liquids, ensuring products have high quality and are safe to use. Depth filters, membrane filters, separators and/or pleated filter cartridges are used for filtering air in semiconductor clean rooms and to reduce particulates on semiconductor wafers during cleaning and etching processes.

Many of these applications create significant demands on the materials used in the filter media. For example, the filter media must be constructed to capture particles having micron ratings from about 0.001 to about 10 microns, and to withstand elevated temperatures for extended periods of time while maintaining its mechanical properties. In some applications, the filter media must be resistant to prolonged exposure to chemicals and corrosion, which can breakdown the material and compromise filter integrity. In addition, the materials must be sufficiently inert to minimize chemical reactions with contaminants that would form undesirable compounds downstream of the filter media.

### SUMMARY

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Filter media and filters are provided that comprise extruded reticular structures, such as nettings or meshes, and may be used in a variety of demanding filter applications that require high purity and/or high resistance to elevated temperatures, chemical reactions, corrosion, stress-cracking and wear.

In one aspect, a filter media comprises an extruded reticular structure comprising an array of intersecting monofilaments or strands bonded to each other. The strands comprise a high-temperature thermoplastic material.

In embodiments, the high-temperature thermoplastic material comprises a high performance engineering thermoplastic material selected to resist deformation at elevated temperatures to avoid compromising the integrity of the filter.

In embodiments, the reticular structure comprises an extruded polymeric netting produced from high-temperature thermoplastic monofilaments or strands. The monofilaments or strands may be thermally bonded together where they cross to form a flexible, compression resistant matrix with a substantial amount of void space. The tight, low profile crisscross pattern of the netting distributes a controlled, predictable flow of fluid through the filter media.

In embodiments, the strands each have a thickness of about 4 mils to about 8 mils, or about 5 mils to about 7 mils, or about 6 mils.

In embodiments, the high-temperature thermoplastic material comprises an aromatic compound. The aromatic compound may comprise one or more aromatic groups that contribute to thermal resistance by restricting chain movement at elevated temperatures.

In various embodiments, the high performance engineering thermoplastic material may comprise an amorphous polymer. Amorphous polymers are generally defined as polymers with a random, coiled molecular structure that gradually softens and does not melt immediately when heated. The amorphous polymer may have a heat deflection temperature (HDT) of at least about 150° C., or at least about 175° C., or at least about 200° C. at a load of about 0.46 MPa as measured according to ASTM D648. The material may have a heat deflection temperature (HDT) of at least about 150° C., or at least about 160° C., or at least about 200° C. at a load of about 1.82 MPa as measured according to ASTM D648.

In embodiments, the amorphous polymer is selected to exhibit thermal stability such that it can endure continuous service at elevated temperatures. The material has a continuous use temperature or continuous service temperature (CUT) of at least about 150° C., or at least about 170° C., or at least about 180° C., or at least about 200° C., as measured according to UL 746. The CUT is defined as the highest temperature at which a material can be used, for prolonged periods, without a significant change in its properties. Typically measured CUT properties include tensile strength, tensile elongation, impact resistance, and dielectric strength.

In embodiments, the amorphous polymer may have a glass transition temperature of the amorphous phase at least about 185° C., or at least about 200° C., or at least about 220° C. In embodiments, the amorphous polymer may have a maximum service temperature of at least about 140° C. or at least about 170° C. or at least about 200° C.

In various embodiments, the high performance engineering thermoplastic material may comprise a semi-crystalline polymer. A semi-crystalline polymer is a polymer with a molecular structure that is partially crystalline and partially amorphous. The crystalline polymer chains are folded and stacked in an ordered structure, while the amorphous chains are entangled and have no long-range order. Semi-crystalline polymers generally have a sharp melting point wherein they rapidly change into a liquid.

The semi-crystalline polymer may have a heat deflection temperature (HDT) of at least about 70° C., or at least about 90° C., or at least about 140° C. at a load of about 0.46 MPa as measured according to ASTM D648. The material may have a heat deflection temperature (HDT) of at least about 50° C., or at least about 70° C., or at least about 100° C., or at least about 150° C. at a load of about 1.82 MPa as measured according to ASTM D648.

In embodiments, the semi-crystalline polymer is selected to exhibit thermal stability such that it can endure continuous service at elevated temperatures. The material has a continuous use temperature or continuous service temperature (CUT) of at least about 140° C., or at least about 170° C., or at least about 200° C., or at least about 225° C., as measured according to UL 746. The CUT is defined as the highest temperature at which a material can be used, for prolonged periods, without a significant change in its properties.

In embodiments, the semi-crystalline polymer may have a glass transition temperature of at least about 85° C., or at least about 100° C., or at least about 135° C., or at least about 165° C. Preferred semi-crystalline polymer crystalline phase melting points range between about 225° C. and 343° C. In embodiments, the semi-crystalline polymer may have a maximum service temperature of at least about 120° C. or at least about 200° C. or at least about 220° C., or at least about 240° C., or at least about 250° C.

In embodiments, suitable materials for the high-temperature thermoplastic material include, but are not limited to, polyether ether ketones (PEEK), high performance polyamide (PPA), polyphenylene sulfides (PPS), polyimides (PI), polyarylene ether sulfones (PAES), polyphenyl sulfones (PPS), polysulfones (PSU), polyetherimides (PEI), polyamide-imides (PAI), polybenzimidazoles (PBI), and combinations thereof.

In other embodiments, the high-temperature thermoplastic material comprises a fluoropolymer. Suitable fluoropolymers include, but are not limited to, fluorinated ethylene propylene (FEP), polyvinylidene fluoride (PDVF), ethylene tetrafluoroethylene (ETFE), ethylene chlorotrifluoroethylene (ECTFE), polytetrafluoroethylene (PTFE), perfluoro alkoxy (PFA) and combinations thereof. In an exemplary embodiment, the fluoropolymer comprises PFA.

In embodiments, the netting comprises a plurality of apertures or holes. The apertures may comprise pores or perforations. The apertures may have any suitable shape, such as circular, diamond shaped, elliptical, trilobal, square, rod, hexagonal, teardrop, oblong, triangular, rectangular, or a combination thereof. In an exemplary embodiment, the apertures have a substantially diamond shape. The apertures may have a size of at least about 50 microns, or at least about 150 microns, preferably at least about 250 microns.

In embodiments, the strands extend at an angle relative to each other of about 30 degrees to about 105 degrees, or about 60 degrees to about 90 degrees, or about 70 degrees. In an exemplary embodiment, the apertures formed by the strands are symmetrical although it will be recognized that the apertures may be non-symmetrical in certain embodiments.

The netting may have a basis weight of about 30 gsm to about 500 gsm, or about 50 gsm to about 200 gsm or about 75 gsm to about 125 gsm. The netting may be designed to have an air permeability of about 500 cfm to about 2000 cfm at 125 Pa, or about 700 cfm to about 1500 cfm at 125 Pa. In some embodiments (discussed below), the air permeability of each layer may differ.

The netting may have a strand density of about 20 strands per inch to about 100 strands per inch, or about 25 strands per inch to about 35 strands per inch.

In another aspect, a spacer for use in a filter is provided. The spacer comprises an extruded reticular structure comprising an array of intersecting monofilaments or strands bonded to each other. The strands comprise a high-temperature thermoplastic material, such as one of those described above. In embodiments, the strands each have a thickness of about 4 mils to about 8 mils, or about 5 mils to about 7 mils, or about 6 mils.

In embodiments, the spacer may be configured for placement between one or more filter media, which may comprise pleated or unpleated filters, porous or semi-permeable membranes or the like. The reticular structure, such as a netting may be configured to mechanically support and protect the membrane from damage to fluid flow through the filter assembly.

In another aspect, a filter is provided comprising the spacer support described above. The filter may comprise a reverse osmosis filter, a wastewater filter, a pleated filter for automotive fuel, break and hydraulic oil or gasoline, a fuel cell, a pleated air filter, an organic gas/air filter, a corrosive acid/base gas or air filter, a blood filter, a facemask, a resin infusion laminate, a semiconductor solution filter or the like.

In another aspect, a filter comprises a filter media, such as a porous or semi-permeable membrane, and an extruded reticular structure disposed adjacent to the membrane. The extruded reticular structure comprises an array of intersecting strands bonded to each other and comprising a high-temperature thermoplastic material.

In embodiments, the filter further comprises a second extruded reticular structure comprising first and second intersecting strands bonded to each other and comprising a high-temperature thermoplastic material. The membrane may be disposed between the first and second extruded reticular structures. In certain embodiments, the filter may comprise a plurality of porous membranes, which may comprise pleated or unpleated filter media, and a plurality of supporting netting disposed between each of the porous membranes. The supporting netting may function as a spacer between the porous membranes.

In embodiments, the permeable membrane comprises one or more materials selected to resist deformation at elevated temperatures to avoid compromising the integrity of the filter. The porous membrane may comprise the same material as the reticular structures. In other embodiments, the permeable membrane comprises a different material as the reticular structures.

In embodiments, the high-temperature thermoplastic material has a heat deflection temperature (HDT) of at least about 150° C., or at least about 200° C. The high-temperature thermoplastic material may have a continuous use temperature (CUT) (or continuous service temperature) of at least about 150° C., or at least about 200° C.

In embodiments, the strands each have a thickness of about 4 mils to about 8 mils, or about 5 to 7 mils, or about 6 mils.

In embodiments, suitable materials for the high-temperature thermoplastic material include, but are not limited to, polyether ether ketones (PEEK), high performance polyamide (PPA), polyphenylene sulfides (PPS), polyimides (PI), polyarylene ether sulfones (PAES), polyphenyl sulfones (PPS), polysulfones (PSU), polyetherimides (PEI), polyamide-imides (PAI), polybenzimidazoles (PBI), and combinations thereof.

In other embodiments, the high-temperature thermoplastic material comprises a fluoropolymer. Suitable fluoropolymers include, but are not limited to, fluorinated ethylene propylene (FEP), polyvinylidene fluoride (PDVF), ethylene tetrafluoroethylene (ETFE), ethylene chlorotrifluoroethylene (ECTFE), polytetrafluoroethylene (PTFE), perfluoro alkoxy (PFA) and combinations thereof. In an exemplary embodiment, the fluoropolymer comprises PFA.

The filter may be configured for use in a variety of industries, such as pulp and paper, food and beverage, steel production, industrial process fluids, wastewater, municipal, automotive, power generation, semiconductor manufacturing, mining/construction, petroleum/chemical refining, medical/pharmaceutical and general manufacturing.

In one exemplary embodiment, the filter comprises a pleated filter for semiconductor etching and cleaning solutions.

The recitation herein of desirable objects which are met by various embodiments of the present description is not meant to imply or suggest that any or all of these objects are present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the disclosure and together with the description, explain the principles of the disclosure.

FIG. 1 is a perspective view of a reticular structure, such as a netting, for a filter;

FIG. 2 is a top view of a netting;

FIG. 3 is a top view of another embodiment of a netting;

FIG. 4 is a top view of another embodiment of a netting;

FIG. 5 is a top view of another embodiment of a netting;

FIG. 6 is a top view of another embodiment of a netting;

FIG. 7 is a top view of another embodiment of a netting;

FIG. 8 illustrates a liquid cartridge filter;

FIG. 9 is a partial cutaway view of a reverse osmosis filter; and

FIG. 10 is a perspective view of a pleated filter cartridge.

### DETAILED DESCRIPTION OF THE EMBODIMENTS

This description illustrates exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Filter media and filters are provided that are formed from extruded polymer materials, such as nettings. The filter media may be particularly useful in one or more of following industries: aerospace, aftermarket products, beverage dispensers, coalescing, computers, data centers, electronics, food service, NVACR, ice machines, industrial enclosures, injection molding, marine, medical, military, portable cooling, power generation, PTAC, reach-in coolers, refrigerated display cases, telecom, transportation, wind turbines, municipal, waste water, automotive, power generation, industrial process fluids, semiconductor, petroleum/chemical refining, pulp and paper, food and beverage, medical/pharmaceutical, general manufacturing and the like. The filter media may be used in a variety of filters including, but not limited to, gas filters, air filters, liquid filters, pleated filters, RO filters, outer sleeves for cylindrical filters, face masks, CPAP filters, vacuum bags, cabin air filters, HVAC furnace filters, residential and commercial air filters, gas turbine, and compressor air intake filters, reverse osmosis filters, pre-filters, panel filters, intake filters, filter presses, rotary drum filters, a clean-in-place (CIP) filter, bag filters, cartridge filters or the like.

For example, various embodiments include liquid filters suitable for use in semiconductor processing, such as microfiltration filters, chemical filters, CMP filters, lithography filters, process gas filters, chemical mechanical polishing filters, wastewater filters, wet etch and clean filters, pleated separators for semiconductor etching and/or filtering air in clean rooms, PFOA filters and the like. In one such embodiment, the filter comprises a pleated filter for semiconductor etching and cleaning solutions. In another embodiment, the filter is configured for use as an air molecular contamination filter for semiconductor manufacturing, e.g., filtering air in clean rooms.

For example, in various embodiments, industrial filters are provided for removing solid and/or liquid contaminants from liquid process streams in refining, petrochemical, chemical, oil and gas, manufacturing paints, organic solvents, ink, petroleum and kerosene industrial water treatment, cosmetics, wineries and pharmaceuticals, including pleated filter cartridges, melt-blown filter cartridges, string wound filter cartridges, membrane filter cartridges, carbon filter cartridges, wound fiber depth style liquid filter cartridges, stainless steel filter cartridges, pleated series liquid cartridges, and other specialty filter cartridges. These filters may be rated from less than about 1 micron to about 100 microns.

For example, hydraulic filters are provided for removing particulate matter from hydraulic fluids. The hydraulic filters may be full flow or partial flow and may include, but are not limited to, oil filters, spin-on filters, return line filters, duplex filters, off-line and in-line filters and tank filters.

For example, various embodiments include filters for the food and beverage industry for removing solid and/or liquid contaminants, such as filters for manufacturing fruit juices and soft drinks, water filters in sinks and pitchers, basket centrifuges for producing salt, disc centrifuges for separating cream from milk, water purification membranes, rotary vacuum drum filters for separating sugar juice from mud, hydro cyclones for purifying starch, disc or tubular centrifuges for refining vegetable seed oils, decanter centrifuges or filter presses for de-watering separated grains in, for example, a distillery or brewery.

For example, various embodiments include oil filters and/or fuel filters, such as diesel fuel filters, hydrocarbon fuels, gasoline fuel filters, canister fuel filters, inline fuel filters, in-tank fuel filters, cartridge fuel filters, carburetor inlet filters, pump-outlet fuel filters, spin-on fuel filters and the like.

For example, various embodiments include gas turbine and compressor air intake filters, panel filters, filter presses, rotary drum filters, water plant treatment filters, biological filters, membrane bioreactor membranes, hydrocarbon filters, diesel filters, fuel filters, hydraulic fluid filters, food and beverage filters, semiconductor filters, microfiltration membranes, downstream membrane filtration, pharmaceutical and medical filters, waste water filters, industrial process and/or municipal filters, pipelines gas turbine and compressor air intake filters, panel filters, cartridge filters, bag filters, clean-in-place (CIP) filters, battery separators and the like.

For example, various embodiments include filters for use in the pharmaceutical manufacturing industry for plasma fractionation, specialty enzymes, vitamins, diagnostics, phytopharmaceuticals, red biotechnology, white biotechnology and may include filters, such as magnetic filters, bag filters, self-cleaning filters, reverse osmosis filter membranes, ultrafiltration filter membranes and nanofiltration filter membranes and the like.

For example, in various embodiments, industrial filters are provided for removing solid and/or liquid contaminants from liquid process streams in refining, petrochemical, chemical, oil and gas, manufacturing paints, organic solvents, ink, petroleum and kerosene industrial water treatment, cosmetics, wineries and pharmaceuticals, including pleated filter cartridges, melt-blown filter cartridges, string wound filter cartridges, membrane filter cartridges, carbon filter cartridges, wound fiber depth style liquid filter cartridges, stainless steel filter cartridges, pleated series liquid cartridges, and other specialty filter cartridges. These filters may be rated from less than about 1 micron to about 100 microns.

For example, hydraulic filters are provided for removing particulate matter from hydraulic fluids. The hydraulic filters may be full flow or partial flow and may include, but are not limited to, oil filters, spin-on filters, return line filters, duplex filters, off-line and in-line filters and tank filters.

For example, various embodiments include municipal filters, such as filters used in water treatment plants. These filters may include, but are not limited to, screen filters, slow sand filters, disc filters, rapid sand filters, membrane filters, bag filters, membrane filters, reverse osmosis filters and the like.

For example, various embodiments include gas pipeline filters, such as turbine air filters, particulate filters, clay treater filters, amine filters, two-stage coalescer-separators, strainers, natural gas pipeline filters, Y-type filters, T-type filters, basket filters, magnetic filters, backwash filters and the like.

For example, various embodiments include power generation filters, such as hydropower generation filters, solar power generation filters, nuclear power generation filters, water filter cartridges, sintered metal filters, wedge wire filters, demister pad filters and the like.

For example, various embodiments include battery separators that serve as a mechanical barrier between the electrodes to prevent shorting while allowing for ionic transport through the electrolyte in the pores. For example, various embodiments include an alkaline battery separator, including, but not limited to, zinc-manganese dioxide (Zn/MnO₂), nickel-cadmium (Ni—Cd,), and nickel-hydrogen (Ni—H₂) batteries. The battery separators may include a substrate comprising blends of polyvinyl alcohol (PVA) fibers and cellulose or cellulose derivatives such as rayon or lyocell.

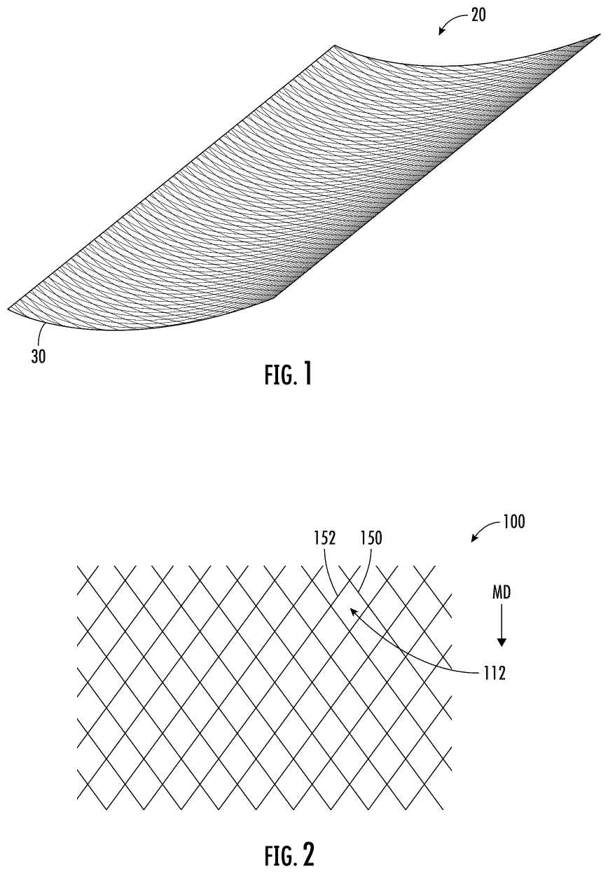

Referring now to FIG. 1, an extruded reticular structure 20 comprises an array of intersecting monofilaments or strands 30 bonded to each other to form a netting or mesh. The strands comprise a high-temperature thermoplastic material. In embodiments, the strands each have a thickness of about 4 mils to about 8 mils, or about 5 mils to about 7 mils, or about 6 mils. Thickness of the overall netting is measured with a mechanical gauge with a 1″ D circular foot that contacts the circular surface. Individual strand dimensions are measured using vernier dial calipers or optical microscopy. The legs of the caliper are opened by moving a wheel. The strands are held with the machine direction facing downward. The stationary leg of the caliper is placed against one side of the strand and the caliper legs are gently closed until snug. The caliper legs are parallel to the machine direction. The thickness (to a thousand of an inch) can be read on the dial scale and the linear scale.

The netting may be formed from any suitable method such as extrusion, co-extrusion, bicomponent, and elastomeric nettings. In an exemplary embodiment, the netting is formed from a mono-extrusion or co-extrusion process. Generally, suitable methods for making the extruded netting includes extruding a polymeric blend composition through dies with reciprocating or rotating parts to form the netting configuration. This creates cross machine direction strands that cross the machine direction strands, which flow continuously. After the extrusion, the netting is then typically stretched in the machine direction using a differential between two sets of nip rollers.

In embodiments, the high-temperature thermoplastic material comprises a high performance engineering thermoplastic material selected to resist deformation at elevated temperatures to avoid compromising the integrity of the filter.

In embodiments, the high-temperature thermoplastic material comprises an aromatic compound, such as an unsaturated chemical compound characterized by one or more conjugated planar rings of atoms joined by covalent bonds of two different kinds. The aromatic compound may comprise one or more aromatic groups that contribute to thermal resistance by restricting chain movement at elevated temperatures.

In certain embodiments, the high performance engineering thermoplastic material may comprise an amorphous polymer. Amorphous polymers are generally defined as polymers with a random, coiled molecular structure that gradually softens and does not melt immediately when heated. The amorphous polymer may have a heat deflection temperature (HDT) of at least about 150° C., or at least about 175° C., or at least about 200° C. at a load of about 0.46 MPa as measured according to ASTM D648. The material may have a heat deflection temperature (HDT) of at least about 150° C., or at least about 160° C., or at least about 200° C. at a load of about 1.82 MPa as measured according to ASTM D648. The HDT is a measure of a polymer's resistance to alteration under a given load at an elevated temperature and is also known as the deflection temperature under load (DTUL) or the heat deflection temperature under load (HDTUL). The HDT tests the stiffness of a material as the temperature increases (i.e., the temperature at which a polymer test bar will be bent at 0.25 mm under a given weight.

In embodiments, the amorphous polymer is selected to exhibit thermal stability such that it can endure continuous service at elevated temperatures. The material has a continuous use temperature or continuous service temperature (CUT) of at least about 150° C., or at least about 170° C., or at least about 180° C., or at least about 200° C., as measured according to UL 746. The CUT is defined as the highest temperature at which a material can be used, for prolonged periods, without a significant change in its properties.

In embodiments, the amorphous polymer may have a glass transition temperature in the amorphous phase of at least about 185° C., or at least about 200° C., or at least about 220° C. In embodiments, the amorphous polymer may have a maximum service temperature of at least about 140° C. or at least about 170° C. or at least about 200° C.

The polymer glass transition temperature was measured with differential scanning calorimetry (DSC). Typical DSC sample scanning rates are 20° C./minute. DSC scanning temperature range is about 25° C. (start) to about 50° C. above the crystalline melting point (for semi-crystalline polymers).

In embodiments, the amorphous polymer may have a room temperature tensile modulus of at least about 2000 MPa, or at least about 2300 MPa, or at least about 2500 MPa, or at least about 2650 MPa, or about 3000 MPa. The amorphous polymer may have a room temperature tensile yield stress of at least about 70 MPa, or at least about 80 MPa, or at least about 100 MPa. The amorphous polymer may have a room temperature tensile yield strain of at least about 6%, or at least about 6.5%, or at least about 7%, or at least about 20% or at least about 50%.

In certain embodiments, the high performance engineering thermoplastic material may comprise a semi-crystalline polymer. A semi-crystalline polymer is a polymer with a molecular structure that is partially crystalline and partially amorphous. The crystalline polymer chains are folded and stacked in an ordered structure, while the amorphous chains are entangled and have no long-range order. Semi-crystalline polymers generally have a sharp melting point wherein they rapidly change into a liquid.

The semi-crystalline polymer may have a heat deflection temperature (HDT) of at least about 70° C., or at least about 90° C., or at least about 140° C. at a load of about 0.46 MPa as measured according to ASTM D648. The material may have a heat deflection temperature (HDT) of at least about 50° C., or at least about 70° C., or at least about 100° C., or at least about 150° C. at a load of about 1.82 MPa as measured according to ASTM D648.

In embodiments, the semi-crystalline polymer is selected to exhibit thermal stability such that it can endure continuous service at elevated temperatures. The material has a continuous use temperature or continuous service temperature (CUT) of at least about 140° C., or at least about 170° C., or at least about 200° C., or at least about 225° C., as measured according to UL 746. The CUT is defined as the highest temperature at which a material can be used, for prolonged periods, without a significant change in its properties.

In embodiments, the semi-crystalline polymer may have a glass transition temperature of at least about 85° C., or at least about 100° C., or at least about 135° C., or at least about 165° C. In embodiments, the semi-crystalline polymer may have a maximum service temperature of at least about 120° C. or at least about 200° C. or at least about 220° C., or at least about 240° C., or at least about 250° C.

In embodiments, the semi-crystalline polymer may have a room temperature tensile modulus of at least about 400 MPa, or at least about 1400 MPa, or at least about 2000 MPa, or at least about 4000 MPa, or about 11,000 MPa. The semi-crystalline polymer may have a room temperature tensile yield stress of at least about 15 MPa, or at least about 30 MPa, or at least about 50 MPa, or at least about 80 MPa, or at least about 100 MPa. The semi-crystalline polymer may have a room temperature tensile yield strain of at least about 1.9%, or at least about 3%, or at least about 30%, or at least about 45% or at least about 300 %.

In embodiments, suitable materials for the high-temperature thermoplastic material include, but are not limited to, polyether ether ketones (PEEK), high performance polyamide (PPA), polyphenylene sulfides (PPS), polyimides (PI), polyarylene ether sulfones (PAES), polyphenyl sulfones (PPS), polysulfones (PSU), polyetherimides (PEI), polyamide-imides (PAI), polybenzimidazoles (PBI), and combinations thereof.

In other embodiments, the high-temperature thermoplastic material comprises a fluoropolymer. Suitable fluoropolymers include, but are not limited to, fluorinated ethylene propylene (FEP), polyvinylidene fluoride (PDVF), ethylene tetrafluoroethylene (ETFE), ethylene chlorotrifluoroethylene (ECTFE), polytetrafluoroethylene (PTFE), perfluoro alkoxy (PFA) and combinations thereof. In an exemplary embodiment, the fluoropolymer comprises PFA.

The netting may include additional materials for color, UV stabilizers, antistatics, flame retardant additives, antimicrobial additives, such as silver, triclosan, heavy metals and the like.

Each layer of netting may have a basis weight of about 30 gsm to about 500 gsm or about 50 gsm to about 200 gsm or about 75 gsm to about 125 gsm. The netting may be designed to have an air permeability of about 500 cfm to about 2000 cfm at 125 Pa, or about 700 cfm to about 1500 cfm at 125 Pa.

The netting comprises a plurality of apertures or holes. The apertures may comprise pores or perforations. The apertures may have any suitable shape, such as circular, diamond shaped, elliptical, trilobal, square, rod, hexagonal, teardrop, oblong, triangular, rectangular, or a combination thereof. In an exemplary embodiment, the apertures have a substantially diamond shape. The apertures may have a size of at least about 50 microns, or at least about 150 microns, preferably at least about 250 microns.

In embodiments, the strands extend at an angle relative to each other of about 30 degrees to about 105 degrees, or about 60 degrees to about 90 degrees, or about 70 degrees, or about 75 degrees depending on the application. In an exemplary embodiment, the apertures formed by the strands are symmetrical although it will be recognized that the apertures may be non-symmetrical in certain embodiments.

The netting may have a strand density of about 20 strands per inch to about 100 strands per inch, or about 25 strands per inch to about 35 strands per inch or about 28 stands per inch to about 30 strands per inch. Strand count (per inch) was measured with an SPI measurement template (6×6 inch) aluminum template and the Bausch & Lomb linen tester (Model N8869 or approved equivalent) per the following procedure: (1) Cut a full width sample from a roll and place on a flat surface. Samples of “sleeve” materials should be cut open along one edge and opened flat; (2) Label side that touches the spreader (inside strands) as Side A and label side that does not touch the spreader (outside strands) as Side B; (3) With Side B facing down, lay the template near the center of the sample and determine the “Bottom” strand count (Side B) and “Top” strand count (Side A) using the counting instrument and the template; (4) Determine the average strand count for both Side A and Side B strands by dividing the number of strands counted by 3; and (5) Report the average strand count for Side A and Side B to the nearest tenth of a strand.

Referring now to FIG. 2, in one embodiment a netting 100 comprises apertures 112 formed from a first series of strands 150 extending in one direction and a second series of strands 152 extending in a generally crosswise or transverse direction. The strands 150, 152 extend in directions relative to each other such that apertures 112 have a substantially diamond shape. The first and second sets of strands 150, 152 are extruded polymeric elongate members which cross and intersect during extrusion to form the net-like structure. The strands could also be formed of extruded strands that are knitted together rather than crossed during extrusion. In an exemplary embodiment, the apertures 112 formed by the strands are symmetrical although it will be recognized that the apertures may be non-symmetrical in certain embodiments. In the FIG. 2 embodiment, both sets of strands 150, 152 are at an angle to the machine direction (MD) and have substantially the same number and size (e.g., thickness). MD is the direction a material moves or unwinds through a machine.

In some embodiments, the strands are made of the same material. In other embodiments, the first set of strands 150 are made of a different material than the second set of strands 152. For example, the netting may include 10 to 90 wt. % of the material of the first set of strands 150 and 10 to 90 wt. % of the material of the second set of strands 152. In still other embodiments, the netting may include 45 to 55 wt. % of the material of strands 150 and 45 to 55 wt. % of the material of strands 152.

FIGS. 3-6 show several additional examples of nettings that can be used with the filter media described herein. FIG. 3 illustrates an example of an asymmetrical netting 200 wherein both sets of strands 250, 262 are at an angle to the MD, but are different in number and/or size. As shown, strands 250 are thinner than strands 262. In addition, there are a greater number of strands 250 than strands 262. The strands 250, 262 form apertures 280 with an asymmetric diamond shape.

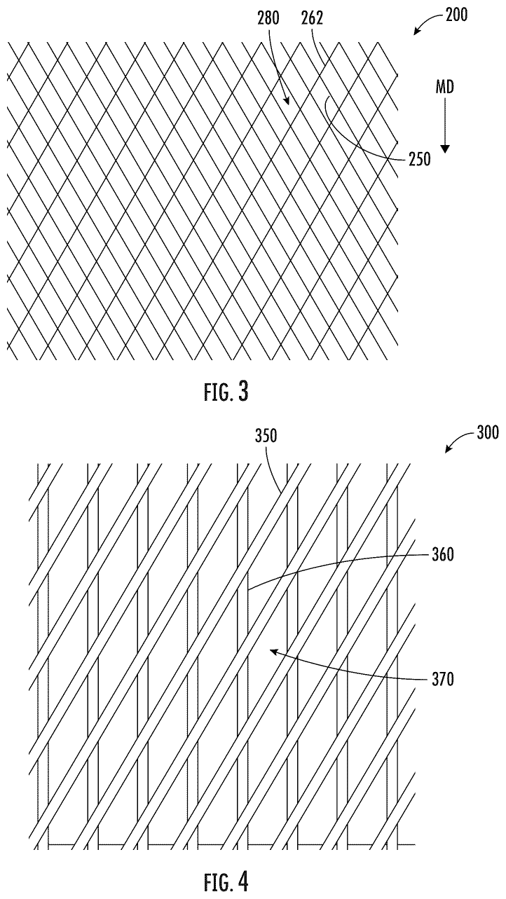

FIG. 4 illustrates another example of a non-symmetrical netting 300 wherein one set of strands 350 is an at angle to the MD and the other set of strands 360 is substantially parallel to the MD. The strands 350, 360 may have the same number and thickness or they may have a different number and/or thickness. The strands 350, 360 form apertures 370 with a substantially diamond shape.

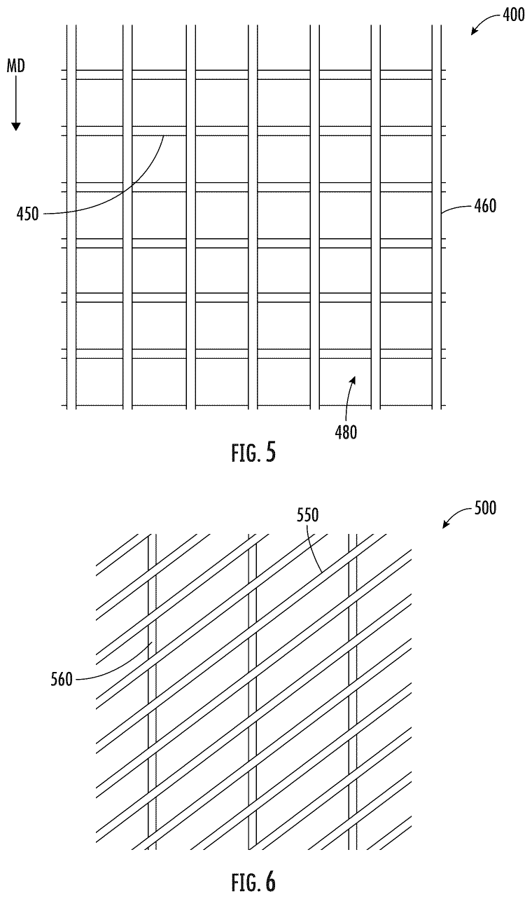

FIG. 5 illustrates another example of a netting 400 wherein one set of strands 450 is substantially parallel to the CD and the other set of strands 460 is substantially parallel to the MD. CD is the direction that is 90 degrees relative to the MD. The strands 450, 460 may have the same number and thickness or they may have a different number and/or thickness. In this embodiment, the strands 450, 460, form apertures 480 that are substantially square in shape.

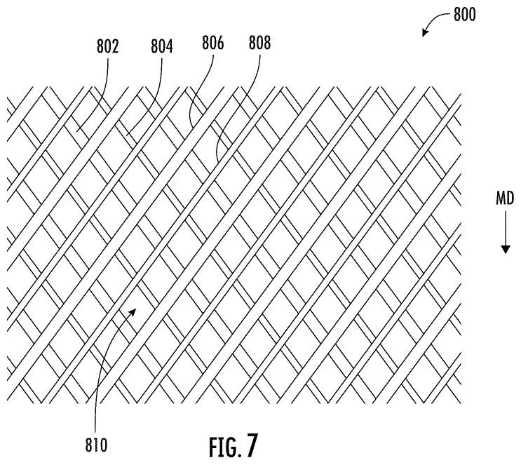

FIG. 6 illustrates another embodiment of a non-symmetrical netting 500 wherein one set of strands 550 is an at angle to the MD and the other set of strands 560 is substantially parallel to the MD. In this embodiment, strands 560 may have different thicknesses as they extend across the width or length of the netting.

FIG. 7 illustrates another embodiment of a netting 800 comprising apertures 810 formed from a first series of strands 802, 804 extending in one direction and a second series of strands 806, 808 extending in a generally crosswise or transverse direction. The strands 802, 804 and 806, 808 extend in directions relative to each other such that apertures 810 have a substantially diamond shape, although it will be recognized that the strands can form any suitable shape, and can also include any of the configurations described above and shown in FIGS. 3-6.

In this embodiment, each of the sets of strands alternative in thickness. As shown, strands 802 are thicker than strands 804 and strands 806 and thicker than strands 808. In some embodiments, a regular pattern may include a repeating sequence of thick and thin strands in one or both directions, such as alternating thick and thin strands in a predetermined order or at fixed intervals across the netting. In other embodiments, the distribution of strand thicknesses may be random or pseudo-random, such that the variation in strand thickness occurs without a fixed sequence or spacing. The random or irregular arrangement can provide localized variations in flexibility, porosity, or load distribution throughout the netting, whereas the regular arrangement can be used to impart uniform directional stiffness or controlled deformation characteristics. The choice between regular and random arrangements can therefore be tailored to meet desired structural, mechanical, or functional properties of the netting in its intended application

In certain embodiments, the difference in strand thickness may also be directional. For example, the strands extending in a first direction (e.g., strands 802, 804) may be thicker than the strands extending in the generally transverse or crosswise direction (e.g., strands 806, 808). This directional variation in strand thickness can be used to tailor the mechanical or functional characteristics of the netting, such as increasing tensile stiffness or load-bearing strength along one axis while maintaining greater flexibility or conformability along the other. In some embodiments, the thicker strands may provide enhanced structural support, dimensional stability, or resistance to elongation, while the thinner, crosswise strands promote reduced weight, increased openness, or improved fluid flow through the apertures 810. Such anisotropic strand configurations can therefore be designed to optimize the performance of the netting for specific orientations or operating conditions

In embodiments, the alternating strand thicknesses fall within the overall range of about 4 mils to about 8 mils, or about 5 mils to about 7 mils, or about 6 mils. For example, the thinner strands (e.g., strands 804 and 808) may have a thickness of about 4 mils to about 5 mils, while the thicker strands (e.g., strands 802 and 806) may have a thickness of about 7 mils to about 8 mils. In some embodiments, the difference in strand thickness between adjacent thick and thin strands may be at least about 1 mil, or about 2 mils, so as to impart a measurable variation in stiffness, flexibility, or flow characteristics across the netting. It will be understood that the particular strand thicknesses and relative differences may be adjusted to achieve desired mechanical or performance properties for a given application.

In some embodiments, the netting is a planar structure, in which all of the strands lie substantially within a single plane. Such planar configurations can provide a uniform, thin profile suitable for applications requiring smooth surfaces, consistent load transfer, or lamination with other layers. In other embodiments, the netting may be a biplanar structure, in which the strands of one set are offset from or interlaced with strands of another set in two distinct but closely spaced planes. The biplanar arrangement can create additional depth or spacing within the netting, improving dimensional stability, drainage, or compressive resilience. In certain implementations, alternating thick and thin strands can be incorporated into either the planar or biplanar construction to further tailor stiffness, flow-through characteristics, or localized deformation behavior.

In certain embodiments, the reticular structures discussed herein may be included as part of a filter device or assembly that traps or absorbs contaminants. In one such embodiment, the filter assembly comprises a porous or semi-permeable membrane and an extruded reticular structure disposed adjacent to the membrane. The extruded reticular structure comprises an array of intersecting strands bonded to each other and comprising a high-temperature thermoplastic material.

The membrane may be porous, non-porous or have skinned surfaces (porous or non-porous). The membrane may be single or multilayer and include those with symmetric or asymmetric (and combinations) of pore size across the thickness of the membrane. The membrane may be pleated or unpleated. The membrane may comprise nonwoven or woven fibers and may be cast or extruded. The fibers may be meltblown, bicomponent meltblown, spunbond or spunlace, bicomponent spunbond, heat-bonded, carded, air-through bonded carded, air-laid, wet-laid, extrusion, co-formed, needlepunched, stitched, hydraulically entangled or combinations thereof.

In embodiments, the filter further comprises a second extruded reticular structure comprising first and second intersecting strands bonded to each other and comprising a high-temperature thermoplastic material. The membrane may be disposed between the first and second extruded reticular structures. For example, the reticular structures or netting may be provided on both the outflow and inflow sides of the membrane, wherein “outflow” and “inflow” refer to the direction of fluid flow through the filter. The netting may be configured to mechanically support and protect the membrane from damage to fluid flow through the filter assembly.

In certain embodiments, the filter assembly may comprise a plurality of porous membranes, which may comprise pleated or unpleated filter media, and a plurality of supporting netting disposed between each of the porous membranes. In various embodiments, the supporting netting includes channels or openings therein for fluid to pass through the supporting netting to the surface of the porous members and ensures separation between pleats of the filter portion. This is beneficial because if the pleats of the filter membranes are packed directly against each other, they could form a fluid tight seal against one another that blocks flow through the filter assembly.

The porous membrane preferably comprises a high-temperature thermoplastic material selected to resist deformation at elevated temperatures to avoid compromising the integrity of the filter and to endure continuous service at elevated temperatures. The porous membrane may comprise the same material as the reticular structures, or it may comprise a different material.

Suitable media for the porous membranes include, but are not limited to, meltblown, spunbond, needle felt, paper/cellulose, microglass medias and combinations thereof.

Suitable materials for the porous membrane include, but are not limited to, polyether ether ketones (PEEK), high performance polyamide (PPA), polyphenylene sulfides (PPS), polyimides (PI), polyarylene ether sulfones (PAES), polyphenyl sulfones (PPS), polysulfones (PSU), polyetherimides (PEI), polyamide-imides (PAI), polybenzimidazoles (PBI), and combinations thereof.

In other embodiments, the porous membrane comprises a fluoropolymer. Suitable fluoropolymers include, but are not limited to, fluorinated ethylene propylene (FEP), polyvinylidene fluoride (PDVF), ethylene tetrafluoroethylene (ETFE), ethylene chlorotrifluoroethylene (ECTFE), polytetrafluoroethylene (PTFE), perfluoro alkoxy (PFA) and combinations thereof. In an exemplary embodiment, the fluoropolymer comprises PFA.

In yet other embodiments, the porous membrane comprises one or more fibers, which may be artificial or natural fibers. Suitable materials for the fibers include, but are not limited to, metallic fibers, carbon fibers, polypropylene (PP), polyesters (PET), PEN polyester, PCT polyester, polybutylene (PBT), ethylene polyester (PET), polylactic acid (PLA), polyamide (PA), co-polyamides, polyethylene, high density polyethylene (HDPE), low density polyethylene (LDPE), cross-linked polyethylene, polycarbonates, polyacrylates, polyacrylonitriles, polyfumaronitrile, polystyrenes, styrene maleic anhydride, polymethylpentene, cyclo-olefinic copolymer or fluorinated polymers, polytetrafluoroethylene, perfluorinated ethylene and hexfluoropropylene or a copolymer with PVDF like P(VDF-TrFE) or terpolymers like P(VDF-TrFE-CFE), propylene, polyimides, polyether ketones, cellulose ester, nylon and polyamides, polymethacrylic, poly(methyl methacrylate), polyoxymethylene, polysulfonates, acrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymer, phenolic, polyurethane, cellulose, styrene or any combination thereof.

In certain embodiments, the fibers within the substrate may comprise polyolefins, polyester, polyethylene (PE), polypropylene (PP), blends of PP and PE, PBT, PET, CoPET, PLA, PA, PHB, PVOH, PVA polyamide and a combination thereof. In an exemplary embodiment, the substrate comprises bicomponent fibers, such as CoPET/PET or HDPE/PET.

The fibers may be manufactured and formed into the substrate in any suitable manner including, but not limited to, meltblown, spunbond or spunlace, gradient spunbond, thermally bonded, bonded carded, air-laid, wet-laid, cellulose wet-laid, glass wet-laid, synthetic wet-laid, composite wet-laid, co-formed, needlepunched, stitched, hydraulically entangled, hydroentangled, ultrasonically bonded or the like. In all of the above examples, the fibers may be hydroentangled or hydraulically entangled. In one exemplary embodiment, the web formation is either drylaid (carded), wetlaid or bicomponent spunbond. In a particularly preferred embodiment, the substrate comprises wetlaid bicomponent fibers, such as CoPET/PET or HDPE/PET.

The fibers within the substrate may have many shapes in cross-section, including without limitation, circular, kidney bean, dog bone, trilobal, barbell, bowtie, star, Y-shaped, and others. With different denier fiber ranges within each portion. The fibers may include biocomponent fibers that include two or more different fibers bonded to each other. The fibers may comprise the same material or different materials. The fibers may comprise biocomponent fibers having a core and a sheath. The core may be concentric or eccentric relative to the longitudinal axis of the sheath.

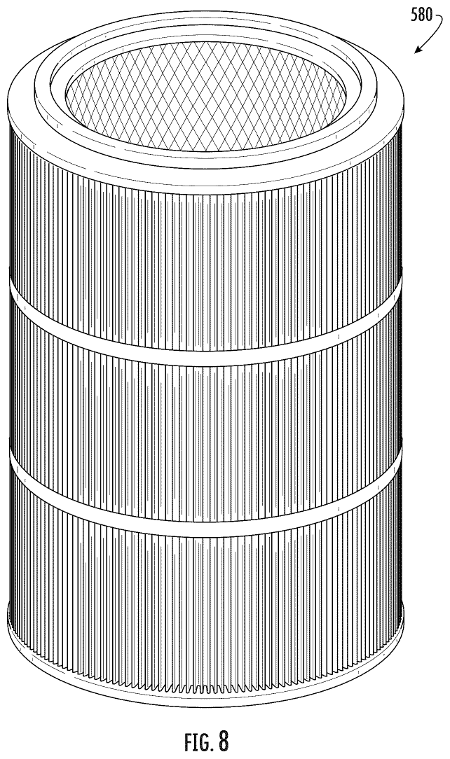

FIG. 8 illustrates a representative liquid filter 580 produced with various embodiments of netting and porous membranes, as described above. The porous membrane is rolled into a cylinder, cone, or other suitable shape and may be used in applications, such as gas turbine and compressor air intake filters, panel filters and the like. A cartridge is a tubular filter medium that is encased inside a housing. The direction of flow in a cartridge filter is typically from outside to the insides of the cartridge. Cartridges are usually made from synthetic or natural fibers and small metal wires. A core, made of stainless or tin-plated steel or polypropylene, is present on the axis of the tubular cartridge to support the media material. A purer filtrate is collected at its core.

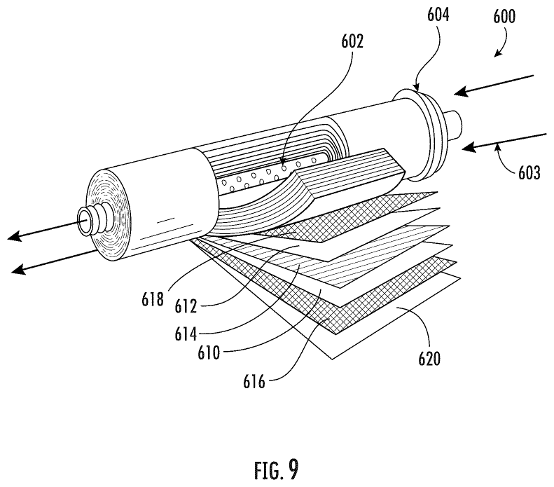

Referring now to FIG. 9, a reverse osmosis (RO) filter 600 will now be described. Filter 600 comprises a series of composite membranes packed into a spiral wound configuration by winding the membranes around a perforated central tube 602. The filter may include one composite membrane, or two or more such membranes. The membrane sheets may be adhered to each other on three sides, with an opening towards the perforate tube 602. Feed water passes through in the direction of arrows 603 and forms into a permeate as the product of the reverse osmosis filtration. The concentrate is the undesirable water that exits the membrane element. Brine seals 604 may be provided at one end of tube 602 to prevent the feed solution from bypassing around the filter element.

As shown, one of the composite membranes of filter 600 includes first and second membranes 610, 612 disposed on either side of a netting spacer 614 (as described above in reference to FIGS. 1-6). Filter 600 further includes first and second feed channel spacers 616, 618 disposed on either side of membranes 610, 612. Spacers 616, 618 may comprise netting material placed between the flat sheets of membranes 610, 612 to promote turbulence in the feed/concentrate stream. In an exemplary embodiment, spacers 616, 618 comprise an extruded reticular structure comprising an array of intersecting monofilaments or strands bonded to each other. The strands comprise a high-temperature thermoplastic material, as discussed above. Filter 600 may further comprise an outer wrap 620 that comprises fiberglass, tape, or a similar suitable material to wrap around the other elements of the RO filter when high pressures are required, e.g., for treating brackish water.

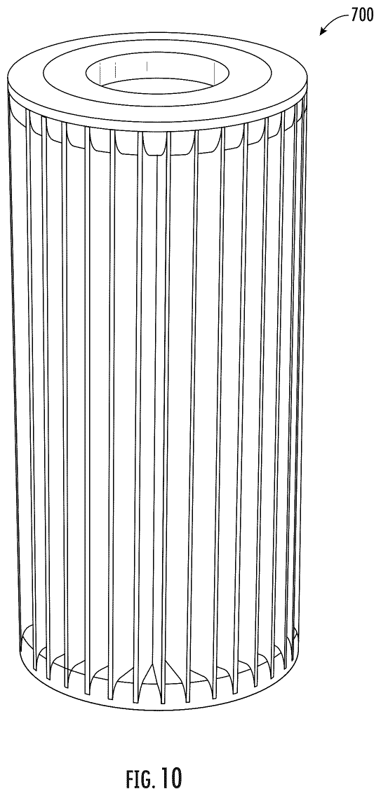

Referring now to FIG. 10, a filter cartridge 700 will now be described. Filter cartridge 700 may be used in a variety of applications such as automotive oil filtering and the like. As shown, filter cartridge 700 generally comprises an annular pleated filter media surrounding a central core. The filter media may be further attached to first and second end caps. The pleated filter media preferably comprises one or more pleated porous membranes and one or more spacers disposed between the membrane. The spacers may comprise an extruded reticular structure comprising an array of intersecting monofilaments or strands bonded to each other. The strands comprise a high-temperature thermoplastic material.

While the previous description is primarily presented with respect to liquid filters, such as RO filters and pleated oil filters, the membrane backers described herein may be used in a variety of industries, such as pulp and paper, food and beverage, steel production, industrial process fluids, municipal, automotive, power generation, semiconductor manufacturing, mining/construction, petroleum/chemical refining, medical/pharmaceutical and general manufacturing.

In certain embodiments, the filter may also include nanoparticles incorporated into the netting and/or the porous membrane. The nanoparticles increase the overall surface area within the filter media, which increases its filtration efficiency and allows for the capture of submicron contaminants without significantly compromising other factors, such as pressure drop (i.e., fluid flow) through the filter. A more complete description of filter medias incorporating nanoparticles can be found in commonly assigned, co-pending International Patent Application Nos. PCT/US23/17921, filed Apr. 7, 2023 and PCT/US24/49846, filed Oct. 3, 2024, the complete disclosures of which are incorporated herein by reference in their entirety for all purposes.

In certain embodiments, one or more of the layers of the filter media may be electrostatically charged such that, for example, contaminants are captured both with mechanical and electrostatic filtration. The fibers can be electrostatically charged using triboelectric charging, corona discharge, electrostatic fiber spinning, hydro charging, charging bars or other known methods. One suitable method for triboelectric charging is described in U.S. Pat. No. 9,074,301, the entire disclosure of which is hereby incorporated by reference herein for all purposes.

One or more different layers of the filter media may comprise charge additives, charge adjuvants or a charge control agent (CCA), or any agent added during the production of a charged layer to increase the charges generated on the layer. The CCA's include but are not limited to metal salt of aluminum or magnesium, lead zirconate titanate, potassium niobate, lithium niobate, lithium tantalate, sodium tungstate, unsaturated carboxylic acid or derivative thereof, unsaturated epoxy monomer or silane monomer, maleic anhydride, monoazo metal compound, alkyl acrylate monomers, alkyl methacrylate monomers, polytetrafluoroethylene, alkylene, arylene, aryleneialkylene, alkylenediarylene, oxydialkylene or oxydiarylene, polyacrylic and polymethacrylic acid compound, organic titanate, quaternary phosphonium trihalozincate salts, organic silicone complex compound, dicarboxylic acid compound, cyclic polyether or non-cyclic polyether and cyclodextrin, complex salt compound of the amine derivative, ditertbutylsalicyclic acid, potassium tetaphenylborate, potassium bis borate, sulfonamides and metal salts, cycloalkyl, alumina particles treated with silane coupling from group consisting of dimethyl silicone compound, azo dye, phthalic ester, quaternary ammonium salt, carbazole, diammonium and triammonium, hydrophobic silica and iron oxide, phenyl, substituted phenyl, naphthyl, substituted naphthyl, thienyl, alkenyl and alkylammonium complex salt compound, sodium dioctylsulfosuccinate and sodium benzoate, zinc complex compound, mica, monoalkyl and dialkyl tin oxides and urthene compound, metal complex of salicyclic acid compound, oxazolidinones, piperazines or perfluorinated alkane, lecigran MT, nigrosine, fumed silca, carbon black, para-trifluoromethyl benzoic acid and ortho-fluoro benzoic acid, poly(styrene-covinylpyridinium toluene sulfonate), methyl or butyltriphenyl complex aromatic amines, triphenylamine dyes and azine dyes, alkyldimethylbenzylammonium salts and combinations thereof. A more complete description of suitable CCAs that may be used can be found in U.S. Pat. No. 10,571,137, which is incorporated herein by reference in its entirety for all purposes.

Alternatively, the charge adjuvant may belong to the group of organic triazine compounds or oligomers with at least one additional nitrogen-containing group, as disclosed for example in WO97/07272, in the following referred to as “triazine based charge adjuvant” or “TB-CA”.

In some embodiments, one or more of the layers may include a nucleating agent, or an agent added to a polymer melt which promotes crystallization of a semi-crystalline polymer from the melt. In an exemplary embodiment, the nucleating agent is a clarifier. The nucleating agent may be selected from a group consisting of benzoate salt, a sorbitol acetate, a rosin based nucleating agent, a carboxylic acid amide, a salt of an organophosphorous acid and mixtures thereof. A more complete description of suitable nucleating agents can be found in U.S. application Ser. No. 18/036,369, filed Nov. 10, 2020, the complete disclosure of which is incorporated herein by reference in its entirety for all purposes.

In certain embodiments, one or more of the extruded reticular layers in the filter media may include a silicone-based coating. In embodiments, the silicone-based coating comprises a reactive silicone macroemulsion. Silicone emulsions are insoluble silicones substantially evenly dispersed in water with the aid of a surfactant. The silicone emulsion may comprise, for example, dimethyl silicone emulsions, amino type silicone emulsions, organo-functional silicone emulsions, resin type silicone emulsions, film-forming silicone emulsions or the like. In an exemplary embodiment, the reactive silicone macroemulsion comprises an amino functional polydimethylsiloxane and/or a polyethylene glycol monotridecyl ether. In embodiments, the amino functional polydimethylsiloxane comprises about 30 to about 40 percent by weight of the coating. In embodiments, the polyethylene glycol monotridecyl ether comprises about 5 to about 10 percent by weight of the coating. A more complete description of suitable silicone-based coatings can be found in commonly assigned co-pending U.S. application Ser. No. 18,464,484, filed Sep. 14, 2022 and U.S. Provisional Patent Application No. 18/560,813 , filed Mar. 4, 2024, the complete disclosures of which are incorporated herein by reference for all purposes.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a filter media comprising an extruded reticular structure comprising an array of intersecting strands bonded to each other. The intersecting strands comprise a high-temperature thermoplastic material.

A second embodiment comprises the first embodiment, wherein the high-temperature thermoplastic material has a heat deflection temperature (HDT) of at least about 150° C.

A third embodiment is any combination of the first 2 embodiments, wherein the high-temperature thermoplastic material has an HDT of at least about 200° C.

A 4^{th} embodiment is any combination of the first 3 embodiments, wherein the high-temperature thermoplastic material has a continuous use temperature (CUT) of at least about 150° C.

A 5^{th} embodiment is any combination of the first 4 embodiments, wherein the high-temperature thermoplastic material has a CUT of at least about 200° C.

A 6^{th} embodiment is any combination of the first 5 embodiments, wherein the intersecting strands have a thickness of about 4 mils to about 8 mils.

A 7^{th} embodiment is any combination of the first 6 embodiments, wherein the thickness is about 6 mils.

An 8^{th} embodiment is any combination of the first 7 embodiments, wherein the high-temperature thermoplastic material comprises an aromatic compound.

A 9^{th} embodiment is any combination of the first 8 embodiments, wherein the high-temperature thermoplastic material comprises a material selected from the group consisting of polyether ether ketones (PEEK), high performance polyamide (PPA), polyphenylene sulfides (PPS), polyimides (PI), polyarylene ether sulfones (PAES), polyphenyl sulfones (PPS), polysulfones (PSU), polyetherimides (PEI), polyamide-imides (PAI), polybenzimidazoles (PBI), and combinations thereof.

A 10^{th} embodiment is any combination of the first 9 embodiments, wherein the high-temperature thermoplastic material comprises a fluoropolymer.

An 11^{th} embodiment is any combination of the first 10 embodiments, wherein the fluoropolymer comprises a material selected from the group consisting of fluorinated ethylene propylene (FEP), polyvinylidene fluoride (PDVF), ethylene tetrafluoroethylene (ETFE), ethylene chlorotrifluoroethylene (ECTFE), polytetrafluoroethylene (PTFE), perfluoro alkoxy (PFA) and combinations thereof.

A 12^{th} embodiment is any combination of the first 11 embodiments, wherein the fluoropolymer comprises PFA.

A 13^{th} embodiment is any combination of the first 12 embodiments, wherein the extruded reticular structure comprises a netting with apertures having a size of about 100 microns to about 500 microns.

A 14^{th} embodiment is any combination of the first 13 embodiments, wherein the netting has a basis weight of about 30 gsm to about 500 gsm.

A 15^{th} embodiment is any combination of the first 14 embodiments, wherein the apertures have a shape selected from the group consisting of circular, diamond shaped, elliptical, trilobal, square, rod, hexagonal, teardrop, oblong, triangular, rectangular, or a combination thereof.

A 16^{th} embodiment is any combination of the first 15 embodiments, wherein the apertures have a substantially diamond shape.

A 17^{th} embodiment is any combination of the first 16 embodiments, wherein the extruded reticular structure has a strand density of about 20 strands per inch to about 100 strands per inch.

An 18^{th} embodiment is any combination of the first 17 embodiments, wherein the strand density is about 25 strands per inch to about 35 strands per inch.

A 19^{th} embodiment is any combination of the first 18 embodiments, wherein the first and second strands extend at an angle relative to each other of about 30 degrees to about 105 degrees.

A 20^{th} embodiment is any combination of the first 19 embodiments, wherein the angle is about 70 degrees.

In another aspect, a filter is provided that comprises the filter media of any of the above 20 embodiments.

In another aspect, a pleated separator for use in semiconductor etching is provided that comprises the filter media of any of the above 20 embodiments.

In another aspect, a first embodiment is a filter comprising a permeable membrane, an extruded reticular structure comprising an array of intersecting strands bonded to each other, the structure disposed adjacent to the permeable membrane. The intersecting strands comprise a high-temperature thermoplastic material.

A second embodiment is the first embodiment, further comprising a second extruded reticular structure comprising an array of intersecting strands bonded to each other.

A third embodiment is any combination of the first 2 embodiments, wherein the permeable membrane is disposed between the first and second extruded reticular structures.

A 4^{th} embodiment is any combination of the first 3 embodiments, wherein the high-temperature thermoplastic material has a heat deflection temperature (HDT) of at least about 150° C.

A 5^{th} embodiment is any combination of the first 4 embodiments, wherein the high-temperature thermoplastic material has an HDT of at least about 200° C.

A 6^{th} embodiment is any combination of the first 5 embodiments, wherein the high-temperature thermoplastic material has a continuous use temperature (CUT) of at least about 150° C.

A 7^{th} embodiment is any combination of the first 6 embodiments, wherein the high-temperature thermoplastic material has a CUT of at least about 200° C.

An 8^{th} embodiment is any combination of the first 7 embodiments, wherein the strands have a thickness of about 4 mils to about 8 mils.

A 9^{th} embodiment is any combination of the first 8 embodiments, wherein the thickness is about 6 mils.

A 10^{th} embodiment is any combination of the first 9 embodiments, wherein the high-temperature thermoplastic material comprises an aromatic compound.

An 11^{th} embodiment is any combination of the first 10 embodiments, wherein the high-temperature thermoplastic material comprises a material selected from the group consisting of polyether ether ketones (PEEK), high performance polyamide (PPA), polyphenylene sulfides (PPS), polyimides (PI), polyarylene ether sulfones (PAES), polyphenyl sulfones (PPS), polysulfones (PSU), polyetherimides (PEI), polyamide-imides (PAI), polybenzimidazoles (PBI), and combinations thereof.

A 12^{th} embodiment is any combination of the first 11 embodiments, wherein the high-temperature thermoplastic material comprises a fluoropolymer.

A 13^{th} embodiment is any combination of the first 12 embodiments, wherein the fluoropolymer comprises a material selected from the group consisting of fluorinated ethylene propylene (FEP), polyvinylidene fluoride (PDVF), ethylene tetrafluoroethylene (ETFE), ethylene chlorotrifluoroethylene (ECTFE), polytetrafluoroethylene (PTFE), perfluoro alkoxy (PFA) and combinations thereof.

A 14^{th} embodiment is any combination of the first 13 embodiments, wherein the fluoropolymer comprises PFA.

A 15^{th} embodiment is any combination of the first 14 embodiments, wherein the extruded reticular structure comprises a netting with apertures having a size of about 100 microns to about 500 microns.

A 16^{th} embodiment is any combination of the first 15 embodiments, wherein the apertures have a shape selected from the group consisting of circular, diamond shaped, elliptical, trilobal, square, rod, hexagonal, teardrop, oblong, triangular, rectangular, or a combination thereof.

A 17^{th} embodiment is any combination of the first 16 embodiments, wherein the apertures have a substantially diamond shape.

An 18^{th} embodiment is any combination of the first 17 embodiments, wherein the extruded reticular structure has a strand density of about 20 strands per inch to about 100 strands per inch.

A 19^{th} embodiment is any combination of the first 18 embodiments, wherein the strand density is about 25 strands per inch to about 35 strands per inch.

A 20^{th} embodiment is any combination of the first 19 embodiments, wherein the first and second strands extend at an angle relative to each other of about 30 degrees to about 105 degrees.

A 21^{st} embodiment is any combination of the first 20 embodiments, wherein the angle is about 70 degrees.

A 22^{nd} embodiment is any combination of the first 21 embodiments, wherein the filter comprises a liquid filter.

A 23^{rd} embodiment is any combination of the first 22 embodiments, wherein the filter comprises an air filter.

A 24^{th} embodiment is any combination of the first 23 embodiments, further comprising a housing comprising an inlet for receiving a liquid and an outlet for discharging the liquid.

A 25^{th} embodiment is any combination of the first 24 embodiments, wherein the housing comprises a cartridge.

A 26^{th} embodiment is any combination of the first 25 embodiments, wherein the filter comprises a reverse osmosis filter.

A 27^{th} embodiment is any combination of the first 26 embodiments, wherein the filter comprises a wastewater filter.

A 28^{th} embodiment is any combination of the first 27 embodiments, wherein the filter comprises an automotive pleated filter.

A 29^{th} embodiment is any combination of the first 28 embodiments, wherein the filter comprises a fuel cell.

A 30^{th} embodiment is any combination of the first 29 embodiments, wherein the liquid filter comprises a microfiltration membrane.

A 31^{st} embodiment is any combination of the first 30 embodiments, wherein the filter comprises a blood filter.

A 32^{nd} embodiment is any combination of the first 31 embodiments, wherein the filter comprises a hydraulic filter.

A 33^{rd} embodiment is any combination of the first 32 embodiments, wherein the filter comprises a facemask.

A 34^{th} embodiment is any combination of the first 33 embodiments, wherein the filter comprises a semi-conductor solution filter.

What is claimed is:

1. A filter media comprising:
an extruded reticular structure comprising an array of intersecting strands bonded to each other; and
wherein the intersecting strands comprise a high-temperature thermoplastic material and have a thickness of about 4 mils to about 8 mils.

2. The filter media of claim 1, wherein the high-temperature thermoplastic material has a heat deflection temperature (HDT) of at least about 150° C.

3. The filter media of claim 1, wherein the high-temperature thermoplastic material has a continuous use temperature (CUT) of at least about 150° C.

4. The filter media of claim 1, wherein the high-temperature thermoplastic material comprises an amorphous polymer.

5. The filter media of claim 4, wherein the amorphous polymer has a glass transition temperature of at least about 185° C.

6. The filter media of claim 1, wherein the high-temperature thermoplastic material comprises a semi-crystalline polymer.

7. The filter media of claim 6, wherein the semi-crystalline polymer has a glass transition temperature of at least about 85° C.

8. The filter media of claim 1, wherein the intersecting strands have a thickness of about 5 mils to about 7 mils.

9. The filter media of claim 1, wherein the high-temperature thermoplastic material comprises an aromatic compound.

10. The filter media of claim 1, wherein the high-temperature thermoplastic material comprises a material selected from the group consisting of polyether ether ketones (PEEK), high performance polyamide (PPA), polyphenylene sulfides (PPS), polyimides (PI), polyarylene ether sulfones (PAES), polyphenyl sulfones (PPS), polysulfones (PSU), polyetherimides (PEI), polyamide-imides (PAI), polybenzimidazoles (PBI), and combinations thereof.

11. The filter media of claim 1, wherein the high-temperature thermoplastic material comprises a fluoropolymer.

12. The filter media of claim 11, wherein the fluoropolymer comprises a material selected from the group consisting of fluorinated ethylene propylene (FEP), polyvinylidene fluoride (PDVF), ethylene tetrafluoroethylene (ETFE), ethylene chlorotrifluoroethylene (ECTFE), polytetrafluoroethylene (PTFE), perfluoro alkoxy (PFA) and combinations thereof.

13. A filter comprising:
a porous membrane;
an extruded reticular structure comprising an array of intersecting strands bonded to each other, the structure disposed adjacent to the porous membrane; and
wherein the intersecting strands comprise a high-temperature thermoplastic material and having a thickness of about 4 mils to about 8 mils.

14. The filter of claim 13, further comprising a second extruded reticular structure comprising an array of intersecting strands bonded to each other, wherein the porous membrane is disposed between the first and second extruded reticular structures.

15. The filter of claim 13, wherein the porous membrane is pleated.

16. The filter of claim 13, wherein the high-temperature thermoplastic material has a heat deflection temperature (HDT) of at least about 150° C.

17. The filter of claim 13, wherein the high-temperature thermoplastic material has a continuous use temperature (CUT) of at least about 150° C.

18. The filter of claim 13, wherein the strands have a thickness of about 5 mils to about 7 mils.

19. The filter of claim 13, wherein the high-temperature thermoplastic material comprises an aromatic compound.

20. The filter of claim 13, wherein the high-temperature thermoplastic material comprises an amorphous polymer.

21. The filter of claim 13, wherein the high-temperature thermoplastic material comprises a semi-crystalline polymer.

22. The filter of claim 13, wherein the high-temperature thermoplastic material comprises a fluoropolymer.
